(19) United States
(12) Patent Application Publication
(10) Pub. No.: US 2011/0068896 A1
(43) Pub. Date: Mar. 24, 2011

(54) COMMUNICATION DEVICE AND METHOD FOR SENDING A QUICK REPLY MESSAGE

(75) Inventor: YAN XIA, Shenzhen City (CN)

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/711,702

(22) Filed: Feb. 24, 2010

(30) Foreign Application Priority Data
Sep. 24, 2009 (CN) 200910307622.8

(51) Int. Cl. G05B 19/00

(52) U.S. Cl. 340/5.83

(57) ABSTRACT

A communication device and method for sending a quick reply message includes creating at least one fingerprint biometric template, setting a quick reply message corresponding to each of the at least one fingerprint biometric template, and determining if computed fingerprint characteristic values of a user match any fingerprint biometric template. The communication device and method further includes sending a quick reply message corresponding to the fingerprint biometric template of the user if the computed fingerprint characteristic values of a user match any fingerprint biometric template and the communication device is in the message editing mode.

### BACKGROUND

1. Technical Field

Embodiments of the present disclosure relate to message management, and more particularly to a communication device and method for sending a quick reply message using the communication device.

2. Description of Related Art

People can use a communication device (e.g., a mobile phone) to send short message service (SMS) messages to contacts. The communication device may provide various quick reply messages for people to reply messages to others quickly when people are busy, such as, at a meeting, driving a car, for example. However, people have to select corresponding options in different menus to find an appropriate quick reply message. Such selection operations may consume time.

What is needed, therefore, is an improved communication device and method for sending a quick reply message using the communication device.

### BRIEF DESCRIPTION OF THE DRAWINGS

FIG. 1 is a block diagram of one embodiment of a communication device.

FIG. 2 is a flowchart of one embodiment of a method for creating a fingerprint biometric template using the communication device of FIG. 1.

FIG. 3 is a flowchart of one embodiment of a method for sending a quick reply message using the communication device of FIG. 1.

FIG. 4 is a schematic diagram of one embodiment of the quick reply message.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

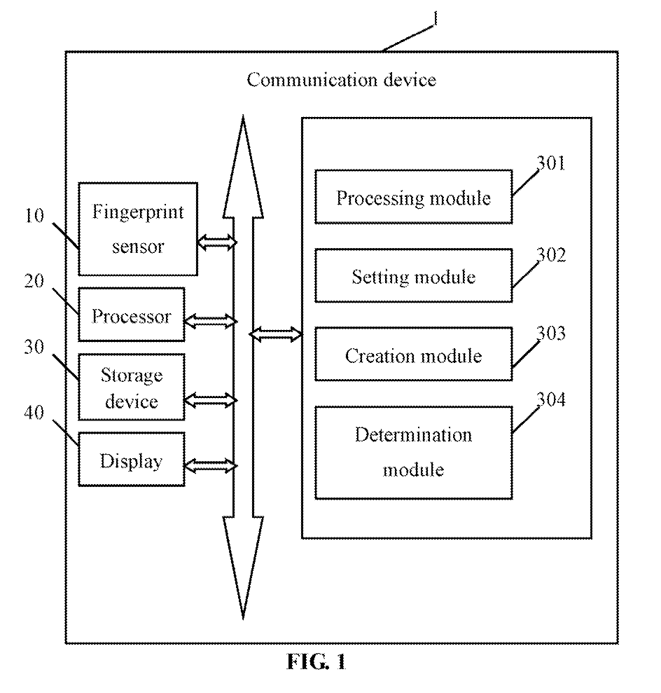

FIG. 1 is a block diagram of one embodiment of a communication device 1. The communication device 1 includes a fingerprint sensor 10. The fingerprint sensor 10 may capture a digital image of a fingerprint in response to receiving finger pressed signals, and acquire fingerprint data from the digital image. In one embodiment, the communication device 1 may be used to preset a correlation between a fingerprint biometric template of the user and a quick reply message, and send the quick reply message to contacts in response to receiving the fingerprint data matched to the fingerprint biometric template. For example, if the user wants to send a quick reply message to people when the user is busy, such as, at a meeting or driving a car, the user may press his/her finger on the fingerprint sensor 10. Then the communication device 1 may recognize the fingerprint data acquired from the fingerprint sensor 10, and send the reply message if the fingerprint data matches the fingerprint biometric template of the user. Detail operations will be provided below.

The communication device 1 may be a mobile phone, a personal digital assistant, a handheld computer, or any other kind of computing device. The communication device 1 also includes a processor 20, a storage device 30, and a display 40. The processor 20 executes one or more computerized operations of the communication device 1 and other applications, to provide the functions of the communication device 1. The storage device 30 stores one or more programs, such as programs of the operating system, other applications of the communication device 1, and various kinds of data, quick reply messages, a contact list, or E-mails, for example. In one embodiment, the communication device 1 may be a mobile phone, and the storage device 30 may be a memory of the communication device 1 or an external storage card, such as a memory stick, a smart media card, a compact flash card, or any other type of memory card. The display 40 may display various information, such as the messages, and user interfaces provided by the communication device 1, for example.

In one embodiment, the communication device 1 further includes a processing module 301, a setting module 302, a creation module 303, and a determination module 304. The modules 301-304 may comprise one or more computerized codes to be executed by the processor 20 to perform one or more operations of the communication device 1. Details of these operations are provided below.

First, fingerprint biometric templates of the user of the communication device 1 need to be created and stored into the storage device 30. The fingerprint biometric templates of the user may be obtained as follows.

The processing module 301 acquires an original fingerprint image of a finger of the user from the fingerprint sensor 10 in response to receiving finger pressed signals. The processing module 301 detects original fingerprint characteristic points in the original fingerprint image, and computes the original fingerprint characteristic values of the finger according to the original fingerprint characteristic points.

In one embodiment, the original fingerprint characteristic points may include main characteristic points and sub-characteristic points. The main characteristic points may include, but are not limited to, a whorl and a triradius in the fingerprint image. The sub-characteristic points may include broken fingerprint ridges and bifurcating fingerprint ridges, for example. The original fingerprint characteristic values include a characteristic point count, characteristic point coordinates, a linked shape of the characteristic points, and relative positions between adjacent characteristic points.

The processing module 301 further stores the original fingerprint image, the original fingerprint characteristic points, and the original fingerprint characteristic values of the finger of the user in the storage device 30.

The creation module 303 creates the fingerprint biometric template of the user according to the original fingerprint characteristic values of the finger of the user. The creation module 303 further stores the fingerprint biometric template in the storage device 30. Multiple fingerprint biometric templates may be created by the creation module 303 and then stored in the storage device 30.

The setting module 302 sets a quick reply message corresponding to the fingerprint biometric template of the user. In one embodiment, a fingerprint biometric template of a middle finger of the user is created, and the setting module 302 sets a quick reply message of “I am at a meeting now. Call you later.” corresponding to the fingerprint biometric template of the middle finger. That is, if the user wants to send the quick reply message of “I am at meeting now. Call you later,” the user may place his/her middle finger on the fingerprint sensor 10 to invoke and send the quick reply message. Detail operations are provided below.

The setting module 302 further stores the quick reply message in the storage device 30.

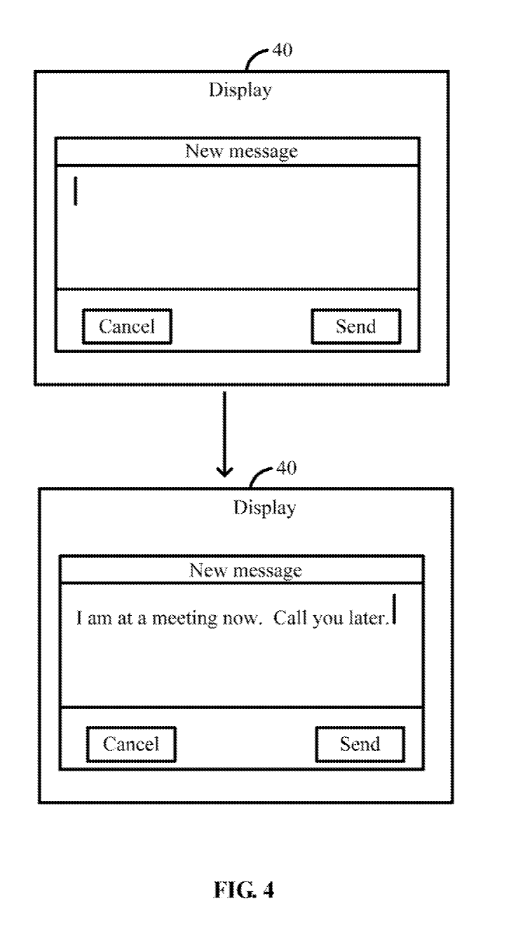

For example, if the user wants to send a quick reply when the communication device 1 has received a message from a contact, the user may control the communication device 1 in a message editing mode. As shown in FIG. 4, under the message editing mode, the display 40 displays that a new message is ready to be edited. Then the user may place his/her finger on the fingerprint sensor 10.

The processing module 22 acquires a fingerprint image from the fingerprint sensor 10 in response to receiving the finger pressed signals. As mentioned above, the processing module 301 further detects fingerprint characteristic points in the fingerprint image, and computes fingerprint characteristic values according to the fingerprint characteristic points.

The determination module 304 determines if the computed fingerprint characteristic values match any fingerprint biometric template of the user, and determines if the communication device 1 is in the message editing mode. If the computed fingerprint characteristic values match the fingerprint biometric template of the user and the communication device 1 is in the message editing mode, the determination module 304 acquires the quick reply message corresponding to the fingerprint biometric template of the user, and sends the acquired quick reply message to the contact. As shown in FIG. 4, the determination module 304 inserts the acquired quick reply message into the new message.

If the computed fingerprint characteristic values do not match any fingerprint biometric template of the user and/or the communication device 1 is not in the message editing mode, no quick reply message will be sent to the contact.

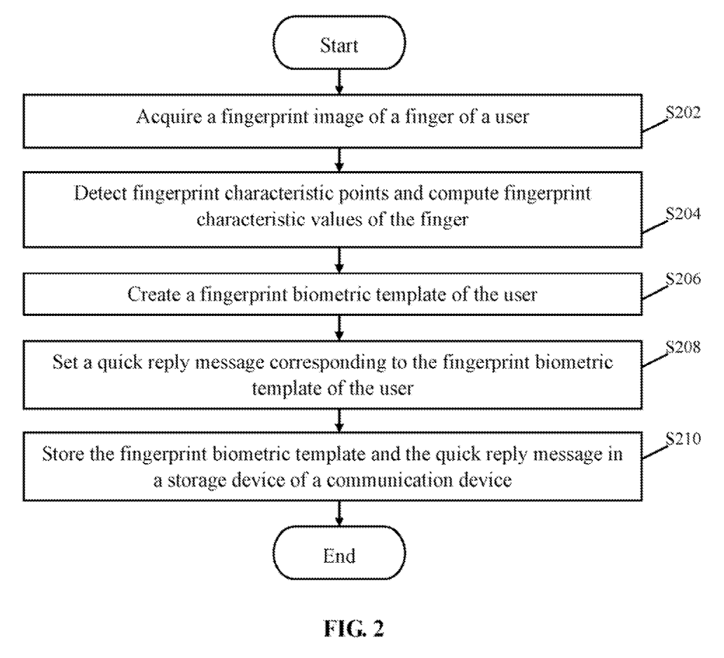

FIG. 2 is a flowchart of one embodiment of a method for creating a fingerprint biometric template of a user of the communication device 1 of FIG. 1. Depending on the embodiment, additional blocks may be added, others removed, and the ordering of the blocks may be replaced.

In block S202, the processing module 301 acquires an original fingerprint image of a finger of the user from the fingerprint sensor 10 in response to receiving finger pressed signals.

In block S204, the processing module 301 detects original fingerprint characteristic points in the original fingerprint image, and computes the original fingerprint characteristic values of the finger according to the original fingerprint characteristic points. As mentioned above, the original fingerprint characteristic points may include main characteristic points and sub-characteristic points. The original fingerprint characteristic values include a characteristic point count, characteristic point coordinates, a linked shape of the characteristic points, and relative positions between adjacent characteristic points.

In block S206, the creation module 303 creates the fingerprint biometric template of the user according to the original fingerprint characteristic values of the finger of the user, and stores the original fingerprint biometric template in the storage device 30.

In block S208, the setting module 302 sets a quick reply message corresponding to the fingerprint biometric template of the user. The quick reply message may be sent to a contact automatically when the corresponding fingerprint biometric template is identified.

In block S210, the setting module 302 stores the quick reply message in the storage device 30.

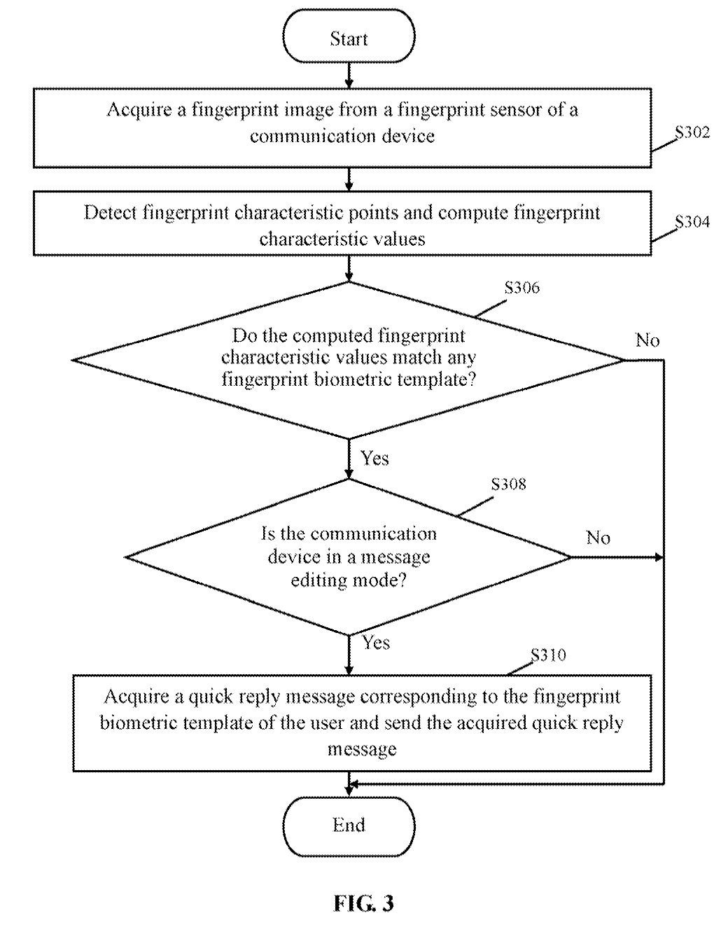

FIG. 3 is a flowchart of one embodiment of a method for sending the quick reply message using the communication device 1 of FIG. 1. Depending on the embodiment, additional blocks may be added, others removed, and the ordering of the blocks may be replaced.

If the user wants to send a quick reply when the communication device 1 has received a message from a contact, the user may place his/her finger on the fingerprint sensor 10.

In block S302, the processing module 22 acquires a fingerprint image from the fingerprint sensor 10 in response to receiving the finger pressed signals.

In block S304, the processing module 301 detects fingerprint characteristic points in the fingerprint image, and computes fingerprint characteristic values according to the fingerprint characteristic points.

In block S306, the determination module 304 determines if the computed fingerprint characteristic values match any fingerprint biometric template of the user. If the computed fingerprint characteristic values match the fingerprint biometric template of the user, in block S308, the determination module 304 determines if the communication device 1 is in the message editing mode.

If the communication device 1 is in the message editing mode, in block S310, the determination module 304 acquires the quick reply message corresponding to the fingerprint biometric template of the user, and sends the acquired quick reply message to the contact.

If the computed fingerprint characteristic values do not match any fingerprint biometric template of the user or the communication device 1 is not in the message editing mode, the procedure ends.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for sending a quick reply message using a communication device, the communication device comprising a fingerprint sensor and a storage device, the method comprising:
creating at least one fingerprint biometric template of a user, each of the at least one fingerprint biometric template comprising original fingerprint characteristic values of a finger of the user;
setting a quick reply message corresponding to each of the at least one fingerprint biometric template of the user;
acquiring a fingerprint image from the fingerprint sensor in response to receiving finger pressed signals;
detecting fingerprint characteristic points in the fingerprint image;
computing fingerprint characteristic values according to the fingerprint characteristic points;
determining if the computed fingerprint characteristic values match any fingerprint biometric template of the user;
determining if the communication device is in a message editing mode if the computed fingerprint characteristic values match the fingerprint biometric template of the user; and
sending the quick reply message corresponding to the fingerprint biometric template of the user if the communication device is in the message editing mode.

2. The method according to claim 1, wherein the creating step comprises:
acquiring an original fingerprint image of a finger of the user from the fingerprint sensor in response to receiving finger pressed signals;
detecting original fingerprint characteristic points in the original fingerprint image;
computing the original fingerprint characteristic values of the user according to the original fingerprint characteristic points; and
storing the original fingerprint image, the original fingerprint characteristic points, and the original fingerprint characteristic values of the user in the storage device.

3. The method according to claim 1, further comprising:
storing the at least one fingerprint biometric template of the user and the quick reply message in the storage device.

4. The method according to claim 1, wherein the fingerprint characteristic points comprise main characteristic points and sub-characteristic points in the fingerprint image.

5. The method according to claim 4, wherein the main characteristic points comprise a whorl and a triradius in the fingerprint image, and the sub-characteristic points comprise broken fingerprint ridges and bifurcating fingerprint ridges in the fingerprint image.

6. The method according to claim 1, wherein the fingerprint characteristic values comprise a characteristic point count, characteristic point coordinates, a linked shape of the characteristic points, and relative positions between adjacent characteristic points.

7. A communication device, the communication device comprising:
a storage device;
at least one processor;
a fingerprint sensor; and
one or more programs stored in the storage device and being executable by the at least one processor, the one or more programs comprising:
a creation module operable to create at least one fingerprint biometric template of a user, each of the at least one fingerprint biometric template comprising original fingerprint characteristic values of a finger of the user;
a setting module operable to set a quick reply message corresponding to each of the at least one fingerprint biometric template of the user;
a processing module operable to acquire a fingerprint image from the fingerprint sensor in response to receiving finger pressed signals, detect fingerprint characteristic points in the fingerprint image, and compute fingerprint characteristic values according to the fingerprint characteristic points;
a determination module operable to determine if the computed fingerprint characteristic values match any fingerprint biometric template of the user, and send the quick reply message corresponding to the fingerprint biometric template of the user if the computed fingerprint characteristic values match the fingerprint biometric template of the user and the communication device is in a message editing mode.

8. The communication device according to claim 7, wherein the processing module is further operable to acquire an original fingerprint image of a finger of the user from the fingerprint sensor in response to receiving finger pressed signals, detect original fingerprint characteristic points in the original fingerprint image, compute the original fingerprint characteristic values of the user according to the original fingerprint characteristic points, and store the original fingerprint image, the original fingerprint characteristic points, and the original fingerprint characteristic values of the user in the storage device.

9. The communication device according to claim 7, wherein the creation module is further operable to store the at least one fingerprint biometric template of the user in the storage device, and the setting module is further operable to store the quick reply message in the storage device.

10. The communication device according to claim 7, wherein the fingerprint characteristic points comprise main characteristic points and sub-characteristic points in the fingerprint image.

11. The communication device according to claim 10, wherein the main characteristic points comprise a whorl and a triradius in the fingerprint image, and the sub-characteristic points comprise broken fingerprint ridges and bifurcating fingerprint ridges in the fingerprint image.

12. The communication device according to claim 7, wherein the fingerprint characteristic values comprise a characteristic point count, characteristic point coordinates, a linked shape of the characteristic points, and relative positions between adjacent characteristic points.

13. A storage medium storing a set of instructions, the set of instructions capable of being executed by a processor to perform a method for sending a quick reply message using a communication device, the communication device comprising a fingerprint sensor and a storage device, the method comprising:
creating at least one fingerprint biometric template of a user, each of the at least one fingerprint biometric template comprising original fingerprint characteristic values of a finger of the user;
setting a quick reply message corresponding to each of the at least one fingerprint biometric template of the user;
acquiring a fingerprint image from the fingerprint sensor in response to receiving finger pressed signals;
detecting fingerprint characteristic points in the fingerprint image;
computing fingerprint characteristic values according to the fingerprint characteristic points;
determining if the computed fingerprint characteristic values match any fingerprint biometric template of the user;
determining if the communication device is in a message editing mode if the computed fingerprint characteristic values match the fingerprint biometric template of the user; and
sending the quick reply message corresponding to the fingerprint biometric template of the user if the communication device is in the message editing mode.

14. The storage medium as claimed in claim 13, wherein the creating step comprises:
acquiring an original fingerprint image of a finger of the user from the fingerprint sensor in response to receiving finger pressed signals;
detecting original fingerprint characteristic points in the original fingerprint image;
computing the original fingerprint characteristic values of the user according to the original fingerprint characteristic points; and
storing the original fingerprint image, the original fingerprint characteristic points, and the original fingerprint characteristic values of the user in the storage device.

15. The storage medium as claimed in claim 13, wherein the method further comprises:
storing the at least one fingerprint biometric template of the user and the quick reply message in the storage device.

16. The storage medium as claimed in claim 13, wherein the fingerprint characteristic points comprise main characteristic points and sub-characteristic points in the fingerprint image.

17. The storage medium as claimed in claim 16, wherein the main characteristic points comprise a whorl and a triradius in the fingerprint image, and the sub-characteristic points comprise broken fingerprint ridges and bifurcating fingerprint ridges in the fingerprint image.

18. The storage medium as claimed in claim 13, wherein the fingerprint characteristic values comprise a characteristic point count, characteristic point coordinates, a linked shape of the characteristic points, and relative positions between adjacent characteristic points.
